(19) United States
(12) Patent Application Publication
(10) Pub. No.: US 2025/0243952 A1
(43) Pub. Date: Jul. 31, 2025

(54) TUBING FOR HIGH-TEMPERATURE SYSTEMS

(71) Applicant: Honeywell International Inc., Charlotte, NC (US)

(72) Inventors: Mehrad Mehr, Morristown, NJ (US); Bahram Jadidian, Watchung, NJ (US)

(21) Appl. No.: 18/422,532

(22) Filed: Jan. 25, 2024

(51) Int. Cl. F16L 9/10; F16L 59/02; F16L 59/14

(52) U.S. Cl. CPC F16L 9/10; F16L 59/028; F16L 59/143

(57) ABSTRACT

An example fluid delivery tubing for a high-temperature system may include a ceramic wall. The ceramic wall may include a low thermal conductivity porous composition. An impermeable coating may seal the ceramic wall. The impermeable coating may have a thickness of less than or equal to 200 microns.

### STATEMENT REGARDING FEDERALLY SPONSORED RESEARCH OR DEVELOPMENT

This invention was made with Government support under 80MSFC21 CA010 awarded by NASA. The Government has certain rights in the invention.

### TECHNICAL FIELD

The present disclosure relates to tubing for high-temperature systems, for example, for furnaces and reactors.

### BACKGROUND

Tubing may be used to deliver fluids or materials to or withdraw fluids or materials from high-temperature systems, for example, furnaces or reactors.

### SUMMARY

In general, the disclosure describes tubing and techniques for forming tubing for high-temperature systems, for example, for furnaces and reactors.

In some examples, an example fluid delivery tubing for a high-temperature system includes a ceramic wall. The ceramic wall includes a low thermal conductivity porous composition. An impermeable coating may seal the ceramic wall. The impermeable coating may have a thickness of less than or equal to 200 microns.

In some examples, an example method for forming a fluid delivery tubing for a high-temperature system includes depositing a precursor composition including at least one of ceramic or glass particles on a ceramic wall. The ceramic wall includes a low thermal conductivity porous composition. The method may further include heating the composition to form an impermeable coating sealing the ceramic wall. The impermeable coating may have a thickness of less than or equal to 200 microns.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a side view of an example tubing for high-temperature systems, the tubing including a ceramic wall and an impermeable coating.

FIG. 1B is a partial enlarged cross-sectional view of the tubing of FIG. 1A.

FIG. 2 is a partial cross-sectional view of an example tubing including a ceramic wall including an outer surface coated with an impermeable coating.

FIG. 3 is a partial cross-sectional view of an example tubing including a ceramic wall including an inner surface coated with an impermeable coating.

FIG. 4 is a partial cross-sectional view of an example high-temperature system including a tubing including a ceramic wall and an impermeable coating.

FIG. 5 is a flowchart representing a technique for forming a tubing.

### DETAILED DESCRIPTION

In general, the disclosure describes tubing and techniques for forming tubing for high-temperature systems, for example, for furnaces and reactors. High-temperature systems, for example, furnaces or reactors, may deliver or transport a fluid in or out of a reaction or a thermal zone. Hermetic tubes may accomplish this function without leaking. The passage of tubes through a thermal barrier (insulation) of the reactors may cause significant thermal loss through conduction of heat through the tube walls. Such thermal loss is detrimental to the efficiency of these reactors.

Low thermal conductivity tubes can significantly increase this thermal efficiency. For example, ceramic materials have a much lower thermal conductivity than metals or alloys, and tubes including ceramic materials exhibit a lower thermal conductivity, and better resistance to heat loss, than tubes including metals or alloys. However, in certain applications (e.g., ultra-efficient reactors or aerospace applications), even conventional ceramic materials may not be sufficient to resist thermal loss. A class of materials that have an even lower thermal conductivity than ceramics are porous (insulation) ceramics. However, porosity affects hermeticity. Thermal loss may be reduced by reducing wall thickness of the tubes. However, such a reduction in wall thickness weakens the strength of the tubes.

Tubing according to the present disclosure includes a ceramic wall and an impermeable coating. The ceramic wall includes a low thermal conductivity porous composition. The impermeable coating may seal the ceramic wall, providing a hermetic seal. The ceramic wall may provide a low thermal conductivity while satisfying mechanical requirements, but being hermetic. The impermeable coating may have a thickness of less than or equal to 200 microns. Providing a coating thickness of less than or equal to 200 microns may provide sufficient sealing while resisting peeling or separation of coating from the ceramic wall, and/or while reducing the amount of material required to hermetically seal the ceramic wall.

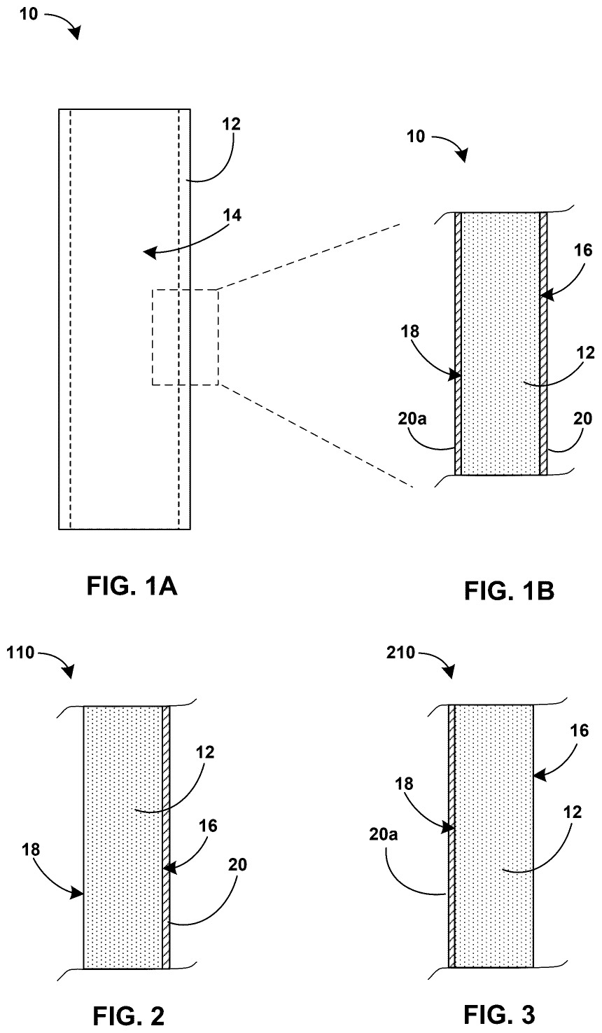

FIG. 1A is a side view of an example tubing 10 for high-temperature systems, tubing 10 including a ceramic wall 12 and an impermeable coating 20. FIG. 1B is a partial enlarged cross-sectional view of tubing 10 of FIG. 1A. Tubing 10 may be a tubing for any suitable high-temperature system. For example, the high-temperature system may include a furnace, a reactor, a combustion chamber, or an engine. Tubing 10 may be configured to transport a fluid, and may be a fluid delivery tubing of the high-temperature system. The fluid may be liquid or gaseous.

Ceramic wall 12 may thermally insulate an interior volume 14 of tubing 10 from an external environment. For example, interior volume 14 of tubing 10 may receive thermal energy from an interior of the high-temperature system. Ceramic wall 12 may resist or prevent transfer of heat from interior volume 14 across ceramic wall 12 to the external environment surrounding tubing 10. Ceramic wall 12 defines an outer surface 16 facing the external environment, and an inner surface 18 facing interior volume 14. Thus, ceramic wall 12 may be configured to resist or reduce heat transfer in a direction between outer surface 16 and inner surface 18.

Ceramic wall 12 may define any suitable cross-section for tubing 10, including circular, elliptical, polygonal, curvilinear, or any predetermined cross-sectional shape. Tubing 10 may be single-walled, double-walled, or include a plurality of walls. For example, at least one wall of tubing 10 is ceramic wall 12. In some examples, tubing 10 includes more than one ceramic wall 12, which may be similar or different in one or more of thickness, size, shape, dimension, or composition.

To promote insulation, ceramic wall 12 may include a porous composition. For example, the porous composition may include a porous ceramic. In some examples, ceramic wall 12 includes at least one of silicon carbide, zirconia, alumina, silica, or mullite, or any ceramic with a relatively low thermal conductivity. In some examples, ceramic wall 12 includes ZAL-45 alumina. In some such examples, ceramic wall 12 consists of ZAL-45 alumina (available from Zircar Ceramics, Inc., Florida, New York). In some such examples, ceramic wall 12 consists essentially of ZAL-45 alumina, for example, except for minor impurities. ZAL-45 alumina is a high density, high-strength, uniformly rigid refractory structure including high-alpha polycrystalline alumina fibers and inorganic binders.

The porous composition may define one or more of isolated pores, isolated channels, fluidically connected pores and/or channels, pores and/or channels extending to one or both of outer surface 16 or inner surface 18, or pores and/or channels isolated from one or both of outer surface 16 or inner surface 18. The pores and/or channels may be geometrically substantially uniform, or non-uniform. For example, the pores and/or channels may define substantially similar maximum major diameters. In other examples, the pores and/or channels may include pores and/or channels that may differ in one or more of a major diameter, a minor diameter, an average dimension, a maximum dimension, a major length, a minor length, or a shape. The pores may be spherical, ellipsoidal, or irregular. The channels may be cylindrical, tubular, or irregular, and may have a substantially uniform or non-uniform cross-section along respective channel lengths.

The porous composition may define any suitable porosity, for example, at least 20%, at least 30%, at least 40%, at least 50%, at least 60%, at least 70%, or at least 80% by volume. The porous composition may define any suitable bulk density, for example, less than equal to 1.00 g/cc, less than equal to 0.90 g/cc, less than equal to 0.80 g/cc, or less than equal to 0.70 g/cc.

The porous composition may have a relatively low thermal conductivity. For example, the thermal conductivity of the porous composition may be relatively low compared to other compositions, for example, compared to non-refractory compositions. For example, the thermal conductivity at 800° C. may be less than or equal to 0.50 W/m° K, less than or equal to 0.30 W/m° K, less than or equal to 0.25 W/m° K, or less than or equal to 0.23 W/m° K.

While the porosity of ceramic wall 12 may facilitate a reduction in thermal conductivity of ceramic wall 12, the porosity may permit diffusion, migration, or transfer of fluid or contaminants from interior 14 of tubing 10 across ceramic wall 12 to the external environment. Tubing 10 may further include impermeable coating 20 to seal ceramic wall 12. For example, impermeable coating 20 may substantially resist migration, diffusion, or transfer of fluid from interior 14. Thus, tubing 10 may exhibit a relatively low thermal conductivity, while being hermetic, such as at operating conditions (e.g., pressure or temperature) experienced by tubing 10.

Impermeable coating 20 may include one or more of a ceramic, a glass, a metal, or an alloy. In some examples, impermeable coating 20 includes a nitride, for example, silicon nitride or boron nitride. In some examples, impermeable coating 20 includes at least a first phase and a second phase. For example, the first phase may include a plurality of particles or grains defining grain boundaries. The second phase may be substantially continuous and occupy inter-grain spaces, such that the first phase and the second phase in combination define an impermeable matrix of impermeable coating 20. In some examples, a matrix or a bulk of impermeable coating 20 is nonporous. For example, the first phase may include a ceramic, and the second phase may include or be formed from a sintering aid. In some examples, the second phase is formed by cooling of a molten composition including the sintering aid, the molten composition occupying inter-grain spaces of the first phase, such that the first phase and the second phase form the impermeable matrix after cooling of the molten composition to a solid composition. In other examples, impermeable coating 20 may include, consist of, or consist essentially of a single phase, for example, including a glass. Thus, the single phase itself may define an impermeable matrix of impermeable coating 20. In some examples, the single phase of impermeable coating 20 is formed by cooling of a molten glass composition applied to ceramic wall 12.

Impermeable coating 20 may have any suitable thickness. For example, impermeable coating 20 may have an average thickness that is 20% or less, 10% or less, 5% or less, 1% or less, 0.1% or less, 0.01% or less, or 0.001% or less of an average thickness of ceramic wall 12. In some examples, impermeable coating 20 has an average thickness of 1000 microns or less, 800 microns or less, 600 microns or less, 500 microns or less, 400 microns or less, or 300 microns or less. For example, impermeable coating 20 may have an average thickness of less than or equal to 200 microns, or less than or equal to 100 microns.

Impermeable coating 20 may have any suitable density. In some examples, impermeable coating 20 has a density higher than that of the ceramic wall. Impermeable coating 20 may have any suitable thermal conductivity. For example, Impermeable coating 20 may have a thermal conductivity that is less than, equal to, or greater than that of ceramic wall 12. Impermeable coating 20 may have any suitable coefficient of thermal expansion (CTE). In some examples, impermeable coating 20 has a CTE that is sufficiently close to a CTE of ceramic wall 12 to resist, reduce, or prevent separation or peeling of impermeable coating 20 from ceramic wall 12. In some examples, the CTE of impermeable coating 20 differs from the CTE of ceramic wall 12 by less than or equal to 10 ppm/° C., less than or equal to 5 ppm/° C., or less than or equal to 2 ppm/° C., or less than or equal to 1 ppm/° C. For example, the difference between the CTE of impermeable coating 20 and the CTE of ceramic wall 12 may be less than or equal to 1 ppm/° C.

Impermeable coating 20 may be deposited on one or both of outer surface 16 or inner surface 18. In the example shown in FIG. 1B, impermeable coating 20 is deposited on outer surface 18, and an impermeable coating 20a is deposited on inner surface 16. Impermeable coating 20a may be identical or similar to impermeable coating 20, or differ from impermeable coating 20 at least one of composition, thickness, or a property (e.g., density, thermal conductivity, or CTE).

FIG. 2 is a partial cross-sectional view of an example tubing 110 including ceramic wall 20 including outer surface 16 coated with impermeable coating 20. In the example shown in FIG. 2, inner surface 18 is free of an impermeable coating. Thus, in some examples, impermeable coating 20 is deposited on only outer surface 16.

FIG. 3 is a partial cross-sectional view of an example tubing 210 including ceramic wall 12 including inner surface 18 coated with impermeable coating 20a. In the example shown in FIG. 3, outer surface 16 is free of an impermeable coating. Thus, in some examples, impermeable coating 20a is deposited on only inner surface 18.

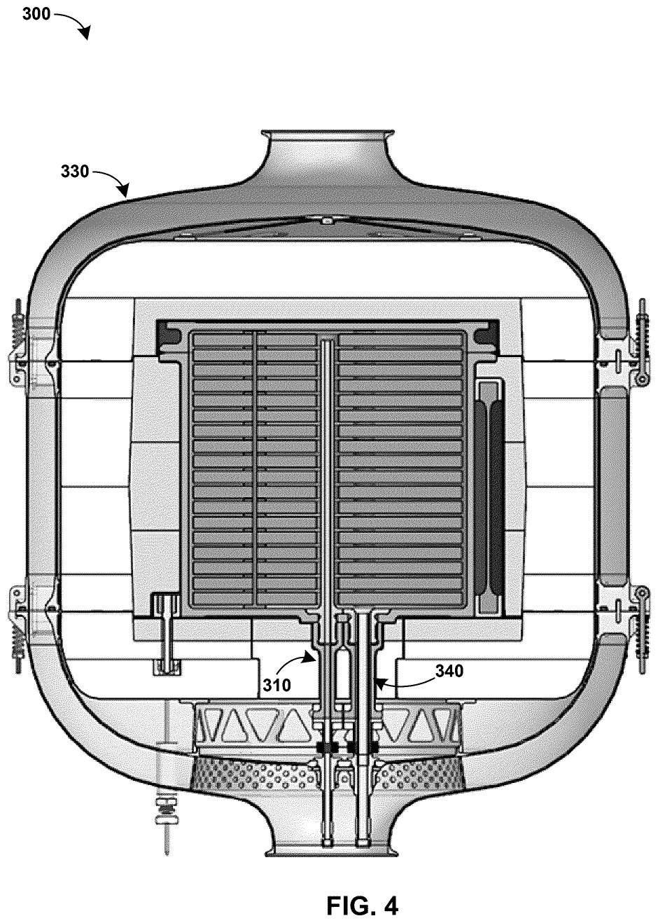

FIG. 4 is a partial cross-sectional view of an example high-temperature system 300 including a tubing 310. Tubing 310 may be substantially similar to tubing 10, tubing 110, or tubing 210 described with reference to FIGS. 1A to 3. System 300 includes a pyrolysis reactor 330. In pyrolysis reactor 330, tubing 310 is an inlet tube for introducing methane into reactor 330 for pyrolysis. Hydrogen gas generated by pyrolysis of the methane exits via outlet tubing 340. In addition to, or instead of inlet tubing 310, outlet tube 340 may be substantially similar to tubing 10, tubing 110, or tubing 210 described with reference to FIGS. 1A to 3. Thus, one or both of inlet tubing 310 or outlet tubing 340 may resist heat transfer from an interior of the respective tubing to the exterior environment, while being hermetic, and resisting diffusion, migration, or transfer of fluid (e.g., methane or hydrogen) across inlet tubing 310 or outlet tubing 340, or at an interface between inlet tubing 310 or outlet tubing 340 and another component of reactor 330.

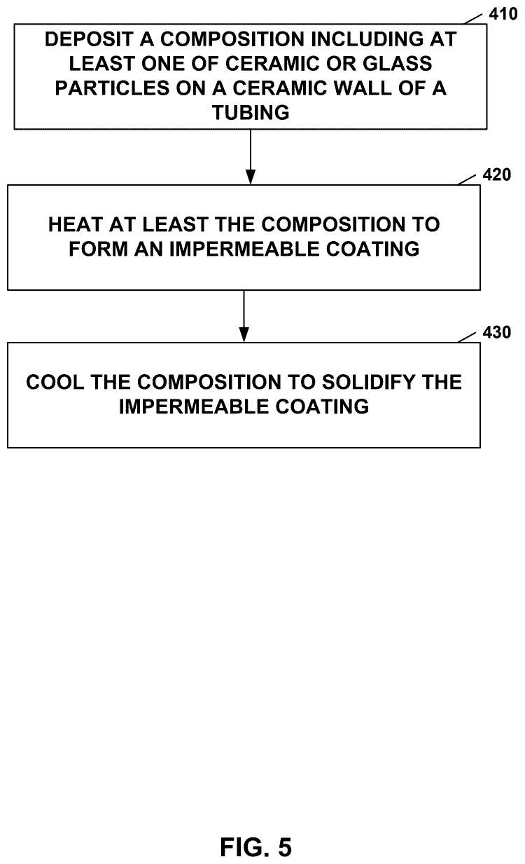

FIG. 5 is a flowchart representing a technique for forming a tubing. As an example, the technique of FIG. 5 is described with reference to tubing 10 of FIGS. 1A and 1B. However, the technique of FIG. 5 may be used to form any tubing according to the present disclosure, and tubes according to the present disclosure may be formed using any suitable technique.

In some examples, an example method for forming fluid delivery tubing 10 for a high-temperature system includes depositing a precursor composition including at least one of ceramic or glass particles on ceramic wall 12 (410). The depositing (410) may include coating or spraying the precursor composition on ceramic wall 12. Ceramic wall 12 may include a low thermal conductivity porous composition. The porous composition may include at least one of silicon carbide, zirconia, alumina, silica, mullite, or any ceramic having a relatively low thermal conductivity. The porous composition may include ZAL-45 alumina.

The precursor composition may include a ceramic or a glass. For example, the precursor composition may include silicon nitride, boron nitride, or any suitable glass-forming composition. The precursor composition may include a paste or a slurry. For example, the paste or the slurry may include an aqueous carrier or solvent, or an organic carrier or solvent. In some examples, the precursor composition includes ceramic particles and at least one sintering aid. The sintering aid may be configured to form a liquid phase in grain boundaries of impermeable coating 20, which may promote hermeticity. In some examples, the precursor composition and the ceramic wall 12 may have the same or similar composition, except for the presence of the sintering aid in the precursor composition. In some examples, the ceramic wall 12 is formed of a wall composition similar to or identical to the precursor composition. In other examples, the precursor composition includes a glass powder, which may form a single-phase glass coating. The depositing (410) may include depositing the composition on one or both of inner surface or the outer surface.

The method may further include heating at least the composition to form impermeable coating 20 (420). Impermeable coating 20 may seal ceramic wall 12 (420). In some examples, the heating (420) includes heating both the composition and ceramic wall 12. The heating (420) may include introducing an assembly including the composition deposited on ceramic wall 12 into a furnace or a thermal tunnel. The heating (420) may further include retaining the assembly at a predetermined temperature for a sufficient period of time to melt the composition into a molten or liquid composition that bonds with ceramic wall 12.

In some examples, the composition does not form impermeable coating 20 after the depositing (410) or after the heating (420), but upon cooling of the heated assembly. For example, impermeable coating 20 may be formed by cooling of the composition (430) to solidify of a molten or liquid composition formed by the heating (420). In some examples, a matrix of impermeable coating 20 is nonporous, for example, after the heating (420) or after the cooling (430).

Impermeable coating 20 may have a thickness of less than or equal to 200 microns. In some examples, the composition deposited on ceramic wall 12 may shrink in response to the heating (420) and/or the cooling (430). Thus, the composition may be deposited with a suitable thickness to form impermeable coating with a predetermined thickness configured to form the final thickness, based on the expected shrinkage or reduction in thickness during processing.

The following clauses illustrate example subject matter described herein.

Clause 1: A fluid delivery tubing for a high-temperature system, the tubing including: a ceramic wall including a low thermal conductivity porous composition; and an impermeable coating sealing the ceramic wall, where the impermeable coating has a thickness of less than or equal to 200 microns.

Clause 2: The tubing of clause 1, where the impermeable coating has a thickness of less than or equal to 100 microns.

Clause 3: The tubing of clauses 1 or 2, where the ceramic wall defines an inner surface and an outer surface, where the impermeable coating is deposited on one or both of the inner surface or the outer surface.

Clause 4: The tubing of clause 3, where the impermeable coating is deposited on only the inner surface.

Clause 5: The tubing of clause 3, where the impermeable coating is deposited on only the outer surface.

Clause 6: The tubing of any of clauses 1 to 5, where a matrix of the impermeable coating is nonporous.

Clause 7: The tubing of any of clauses 1 to 6, where the impermeable coating has a density higher than that of the ceramic wall.

Clause 8: The tubing of any of clauses 1 to 7, where the ceramic wall includes at least one of silicon carbide, zirconia, alumina, silica, or mullite.

Clause 9: The tubing of any of clauses 1 to 8, where the ceramic wall includes ZAL-45 alumina.

Clause 10: The tubing of any of clauses 1 to 9, where the ceramic wall has a thermal conductivity of less than 0.5 W/m° K.

Clause 11: The tubing of any of clauses 1 to 10, where the impermeable coating includes a ceramic or a glass.

Clause 12: The tubing of any of clauses 1 to 11, where the impermeable coating has a coefficient of thermal expansion (CTE) that differs from a CTE of the ceramic wall by less than or equal to 1 ppm/° C.

Clause 13: A method for forming a fluid delivery tubing for a high-temperature system, the method including: depositing a precursor composition including at least one of ceramic or glass particles on a ceramic wall, the ceramic wall including a low thermal conductivity porous composition; and heating the composition to form an impermeable coating sealing the ceramic wall, where the impermeable coating has a thickness of less than or equal to 200 microns.

Clause 14: The method of clause 13, where the precursor composition includes ceramic particles and at least one sintering aid, where the sintering aid is configured to form a liquid phase in grain boundaries of the impermeable coating.

Clause 15: The method of clauses 13 or 14, where the impermeable coating has a thickness of less than or equal to 100 microns.

Clause 16: The method of any of clauses 13 to 15, where the ceramic wall defines an inner surface and an outer surface, the method including depositing the composition on one or both of the inner surface or the outer surface.

Clause 17: The method of any of clauses 13 to 16, where a matrix of the impermeable coating is nonporous.

Clause 18: The method of any of clauses 13 to 17, where the ceramic wall includes at least one of silicon carbide, zirconia, alumina, silica, or mullite.

Clause 19: The method of any of clauses 13 to 18, where the ceramic wall includes ZAL-45 alumina.

Clause 20: The method of any of clauses 13 to 19, where the impermeable coating includes a ceramic or a glass.

Various examples have been described. These and other examples are within the scope of the following claims.

What is claimed is:

1. A fluid delivery tubing for a high-temperature system, the tubing comprising:
a ceramic wall comprising a low thermal conductivity porous composition; and
an impermeable coating sealing the ceramic wall,
wherein the impermeable coating has a thickness of less than or equal to 200 microns.

2. The tubing of claim 1, wherein the impermeable coating has a thickness of less than or equal to 100 microns.

3. The tubing of claim 1, wherein the ceramic wall defines an inner surface and an outer surface, wherein the impermeable coating is deposited on one or both of the inner surface or the outer surface.

4. The tubing of claim 3, wherein the impermeable coating is deposited on only the inner surface.

5. The tubing of claim 3, wherein the impermeable coating is deposited on only the outer surface.

6. The tubing of claim 1, wherein a matrix of the impermeable coating is nonporous.

7. The tubing of claim 1, wherein the impermeable coating has a density higher than that of the ceramic wall.

8. The tubing of claim 1, wherein the ceramic wall comprises at least one of silicon carbide, zirconia, alumina, silica, or mullite.

9. The tubing of claim 1, wherein the ceramic wall comprises ZAL-45 alumina.

10. The tubing of claim 1, wherein the ceramic wall has a thermal conductivity of less than 0.5 W/mK.

11. The tubing of claim 1, wherein the impermeable coating comprises a ceramic or a glass.

12. The tubing of claim 1, wherein the impermeable coating has a coefficient of thermal expansion (CTE) that differs from a CTE of the ceramic wall by less than or equal to 1 ppm/° C.

13. A method for forming a fluid delivery tubing for a high-temperature system, the method comprising:
depositing a precursor composition comprising at least one of ceramic or glass particles on a ceramic wall, the ceramic wall comprising a low thermal conductivity porous composition; and
heating at least the composition to form an impermeable coating sealing the ceramic wall,
wherein the impermeable coating has a thickness of less than or equal to 200 microns.

14. The method of claim 13, wherein the precursor composition comprises ceramic particles and at least one sintering aid, wherein the sintering aid is configured to form a liquid phase in grain boundaries of the impermeable coating.

15. The method of claim 13, wherein the impermeable coating has a thickness of less than or equal to 100 microns.

16. The method of claim 13, wherein the ceramic wall defines an inner surface and an outer surface, the method comprising depositing the composition on one or both of the inner surface or the outer surface.

17. The method of claim 13, wherein a matrix of the impermeable coating is nonporous.

18. The method of claim 13, wherein the ceramic wall comprises at least one of silicon carbide, zirconia, alumina, silica, or mullite.

19. The method of claim 13, wherein the ceramic wall comprises ZAL-45 alumina.

20. The method of claim 13, wherein the impermeable coating comprises a ceramic or a glass.
